(19) United States
(12) Patent Application Publication
(10) Pub. No.: US 2024/0194058 A1
(43) Pub. Date: Jun. 13, 2024

(54) SYSTEM AND METHOD FOR CLASSIFYING INTERSECTIONS BASED ON SENSOR DATA FROM FLEET VEHICLES

(71) Applicant: Mercedes-Benz Group AG, Stuttgart (DE)

(72) Inventors: Thomas Monninger, Sunnyvale, CA (US); Anja Severin, Stuttgart (DE); Mario Aleksic, Stuttgart (DE); Alexander Bracht, Stuttgart (DE); Michael Henzler, Stuttgart (DE); Michael Mink, Stuttgart (DE); Tobias Mahler, Stuttgart (DE); Roland Ortloff, Stuttgart (DE); Andreas Silvius Weber, Stuttgart (DE)

(21) Appl. No.: 18/076,574

(22) Filed: Dec. 7, 2022

(51) Int. Cl. G08G 1/01; G08G 1/0969

(52) U.S. Cl. CPC G08G 1/0133; G08G 1/0112; G08G 1/0969

(57) ABSTRACT

A system can perform a method that includes receiving sensor data from a subset of human-driven vehicles that have moved through an intersection in a region, where the sensor data indicates a respective set of trajectories of respective human-driven vehicles of the subset through the intersection. The method can further include processing the sensor data to classify driving behavior of each human-driven vehicle of the subset of human-driven vehicles through the intersection. The method can further include classifying the intersection to label an autonomy map to include pass-through information for at least one of autonomous vehicles or semi-autonomous vehicles driving through the intersection.

### BACKGROUND

Automated vehicle features such as lane following and emergency braking involve computer decision-making that utilizes limited parameters, such as maintaining the vehicle between two lane markers or responding to immediate velocity differentials (e.g., in radar data) respectively. In more urban traffic environments, more advanced decision-making involving far more parameters is required to enable safe traversals of traffic intersections. In current implementations, right-of-way rules and intersection types are typically derived by heuristics from road signage or traffic control elements (e.g., signals) from recorded ground truth maps. However, faulty or missing labels for traffic control elements can lead to incorrect classification of intersection types.

### SUMMARY

Systems, methods, and computer programs products are described for classifying road network intersections based on sensor data received from human-driven fleet vehicles operating throughout a road network. In various embodiments, a computing system can receive sensor data from human-driven vehicles that have moved through an intersection. The sensor data can indicate a respective set of trajectories and behaviors of the human-driven vehicles through the intersection. The computing system can process the respective set of trajectories and behaviors to generate vehicle traces of each of the vehicles passing through the intersection, where the traces indicate temporal positional information of the vehicle. The system may then classify the driving behavior of each human-driven vehicle of the subset of human-driven vehicles through the intersection, and then classify the intersection (e.g., as a pass-through intersection or signal-controlled intersection). Upon classifying the intersection, the computing system can, for example, train or otherwise label a ground-truth map to include a set of rules or pass-through information for at least one of autonomous vehicles or semi-autonomous vehicles driving through the intersection. As provided herein, the pass-through information can comprise at least one of a set of pass-through rules for each lane of the intersection, or a set of labels indicating traffic signals and/or signage that control the intersection.

In certain examples, the computing system can superimpose each of the respective set of trajectories to a lane which is represented by map data of the intersection. Each of the respective set of trajectories can describe a chronological sequence of vehicle motion of a corresponding human-driven vehicle through the intersection. In such examples, the computing system can classify the driving behavior of each human-driven vehicle of the subset through the intersection based on superimposing each of the respective set of trajectories on the map data. In further examples, the computing system can classify the intersection using one of a heuristic approach or a learning-based approach based on a temporal and aggregated distribution of the respective set of trajectories represented by the map data.

In various examples, the computing system can classify the intersection by determining a crossing-type for each lane segment of the intersection based on the respective set of trajectories. As provided herein, the crossing-type can correspond to at least one of a sign-controlled crossing type, a signal-controlled crossing type, an all-way stop crossing type, a priority road crossing type, or a no control crossing type. Detailed description of crossing types and their characteristics is provided below.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system implementing intersection classification based on sensor data from fleet vehicles, according to examples described herein;

FIG. 2 is a block diagram illustrating an example computing system including specialized modules for implementing intersection classification based on sensor data from fleet vehicles, according to examples described herein;

FIG. 3 depicts a mapped intersection in which vehicle traces are superimposed on map data over a time period based on sensor data from fleet vehicles, according to examples described herein;

FIGS. 4A and 4B depict acceleration and speed information of the respective vehicle traces through an intersection, according to examples described herein; and

FIGS. 5 and 6 are flow charts describing methods of intersection classification based on sensor data from fleet vehicles, according to examples described herein.

### DETAILED DESCRIPTION

A computing system is described herein that classifies intersections using sensor data received from human-driven vehicles (or “fleet vehicles”) for the purpose of improving routing for semi-autonomous and/or fully autonomous vehicles. In various examples, the computing system can include a communication interface to communicate, over one or more networks, with human-driven vehicles operating throughout a region. The computing system can receive, over the one or more networks, sensor data from a subset of the human-driven vehicles that have moved through an intersection in the region. As provided herein, the sensor data can indicate a respective set of trajectories of the human-driven vehicles through the intersection, and can include position data from positioning systems of the fleet vehicles (e.g., from a GPS device or other GNSS device), velocity data from wheel spin sensors, or other odometry data from one or more odometry sensors of the fleet vehicles (e.g., yaw rate sensors, acceleration sensors, inertial measurement units, braking sensors, etc.).

According to examples described herein, the computing system can process the sensor data classify driving behavior of each human-driven vehicle through the intersection, and classify the intersection to, for example, train a ground-truth map to include a set of rules (e.g., right-of-way rules) for autonomous vehicles and/or semi-autonomous vehicles driving through the intersection. Additionally or alternatively, the classification of intersections in the manner described herein can be performed for scene mining and/or change detection for autonomous vehicles, as described in detail below. In certain implementations, the computing system can superimpose, for each human-driven vehicle of the subset, each of the respective set of trajectories to a lane which is represented by map data of the intersection. The computing system can further generate vehicle traces for each vehicle through the intersection, which can include the temporal distribution of motion of each vehicle through the intersection. The computing system may then classify the driving behavior of each human-driven vehicle through the intersection based on the vehicle traces.

As provided herein, the “driving behavior” of a collective set of fleet vehicles through a respective intersection can provide an indication of the characteristics of intersection. Such driving behaviors can correspond to any combination of a fleet vehicle passing through an intersection without slowing, slowing down for an intersection but maintaining a relatively high speed, slowing down to a significantly reduced speed through the intersection (e.g., indicating a potential yield sign or crosswalk), stopping at the intersection for a prolonged period of time (e.g., indicating a pause at a red light), stopping for a brief moment and proceeding (e.g., indicating a stop sign), making a turn, initiating a right turn, pausing, and completing the turn (e.g., indicating a yield sign and/or crosswalk), passing through a right turn (e.g., indicating right-of-way for a right turn), and the like.

As further provided herein, the “crossing type” of an intersection can correspond to any real-world intersection, such as a sign-controlled crossing type, a signal-controlled crossing type, an all-way stop crossing type (e.g., a four-way stop controlled by stop signs), a priority road crossing type (e.g., a two-way stop controlled by stop signs), a mixed crossing type (a combination of sign controlled and signal controlled), a no control crossing type (an intersection having no signals or signs present), and any other combination of crossing types. A sign-controlled crossing type corresponds to an intersection that includes one or more stop signs, yield signs, or other signs that signal a regulated behavior for drivers. Such intersections can comprise all-way stops, four-way stops, two-way stops, other multiple-way stops, or single-way stops. A signal-controlled crossing type can correspond to any intersection in which a plurality of pathways through the intersection are controlled by one or more traffic signals that dictate regulated behavior at the intersection (e.g., red, yellow, and green pass-through signal states, red, yellow, and green turning signal states, etc.). Any combination of crossing type can be used to classify an intersection based on the driving behaviors of fleet vehicles, in accordance with the processes described herein.

In various examples, the computing system can classify the intersection heuristically based on a temporal and aggregated distribution of the respective vehicle traces represented by the map data. In further examples, the computing system can classify the intersection by determining a crossing-type for each lane segment of the intersection based on the individual vehicle traces, where the crossing-type for the lane segment can correspond to a sign-controlled right-of-way or a signal-controlled right-of-way. As described herein, each of the respective set of vehicle traces describes a chronological sequence of vehicle motion of the human-driven vehicle through the intersection. Thus, the computing system can derive the driving behaviors of the fleet vehicles through the intersection, and determine various parameters of the intersection, such as rights-of-way at any given time and location (e.g., based on traffic signal states), crosswalk locations, any road signage (e.g., yield signs or stop signs), pedestrian crosswalk signals, and the like.

In certain implementations, the computing system can perform one or more functions described herein using a learning-based approach, such as by executing an artificial neural network (e.g., a recurrent neural network, convolutional neural network, etc.) or one or more machine-learning models to process the respective set of trajectories and classify the driving behavior of each human-driven vehicle through the intersection. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

As further provided herein, a “right-of-way rule” or “a set of right-of-way rules” is defined as a set of priorities for multiple competing pathways, which can include road lanes (e.g., turning lanes, merging lanes, roundabouts, etc.), pedestrian crosswalks, rail crossings, and the like. The set of priorities determine which competing pathways must yield at any given time to other competing pathways. In common practice, right-of-way is regulated by lane markings, traffic control signals, traffic signage, and local regulations.

As further provided herein, an “autonomy map” or “autonomous driving map” comprises a ground truth map recorded by a mapping vehicle using various sensors (e.g., LIDAR sensors and/or a suite of cameras or other imaging devices) and labeled to indicate traffic and/or right-of-way rules at any given location. For example, a given autonomy map can be human-labeled based on observed traffic signage, traffic signals, and lane markings in the ground truth map. In further examples, reference points or other points of interest may be further labeled on the autonomy map for additional assistance to the autonomous vehicle. Autonomous vehicles or self-driving vehicles may then utilize the labeled autonomy maps to perform localization, pose, change detection, and various other operations required for autonomous driving on public roads. For example, an autonomous vehicle can reference an autonomy map for determining the traffic rules (e.g., speed limit) at the vehicle's current location, and can dynamically compare live sensor data from an on-board sensor suite with a corresponding autonomy map to safely navigate along a current route.

Among other benefits, the examples described herein achieve a technical effect of deriving intersection types and characteristics independent of traffic signs and other infrastructure. A technical advantage of the examples described herein is the use of derived intersections for the purpose of mapping for autonomous vehicle operation without the need for human labeling, which allows for integration of human driving behavior while implicitly correcting or otherwise handling cases in which traffic elements are missing from autonomy maps or are incorrectly labeled.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer-programs, or a computer usable carrier medium capable of carrying such a program.

### Example Computing System

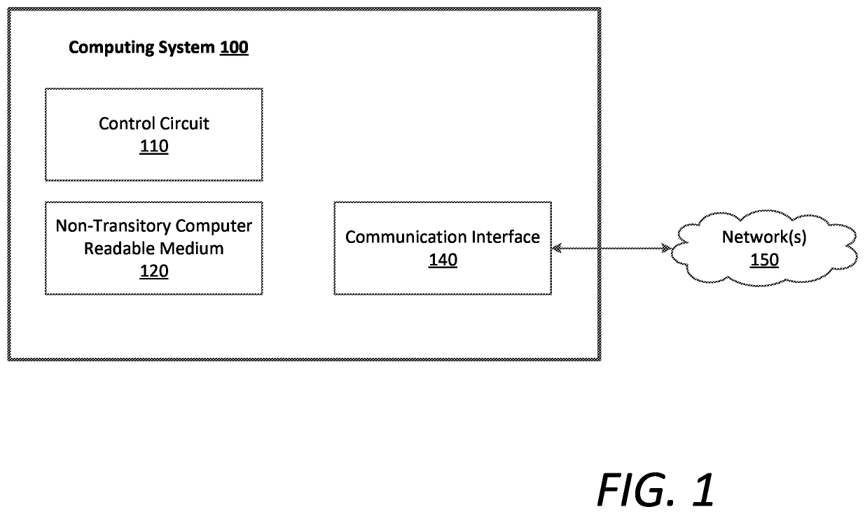

FIG. 1 is a block diagram depicting an example computing system 100 implementing right-of-way determination based on sensor data from fleet vehicles, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”).

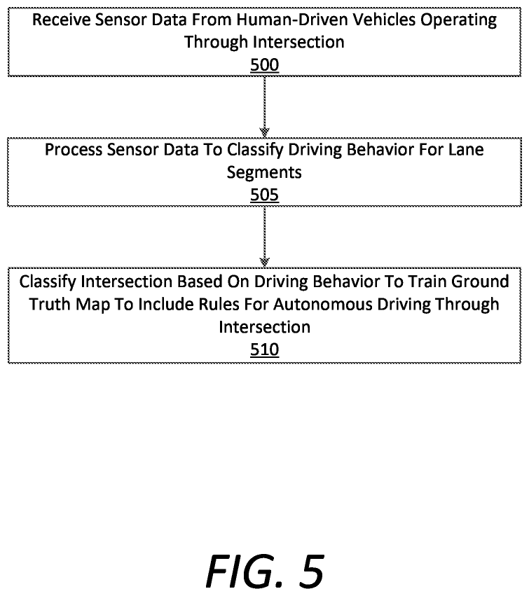

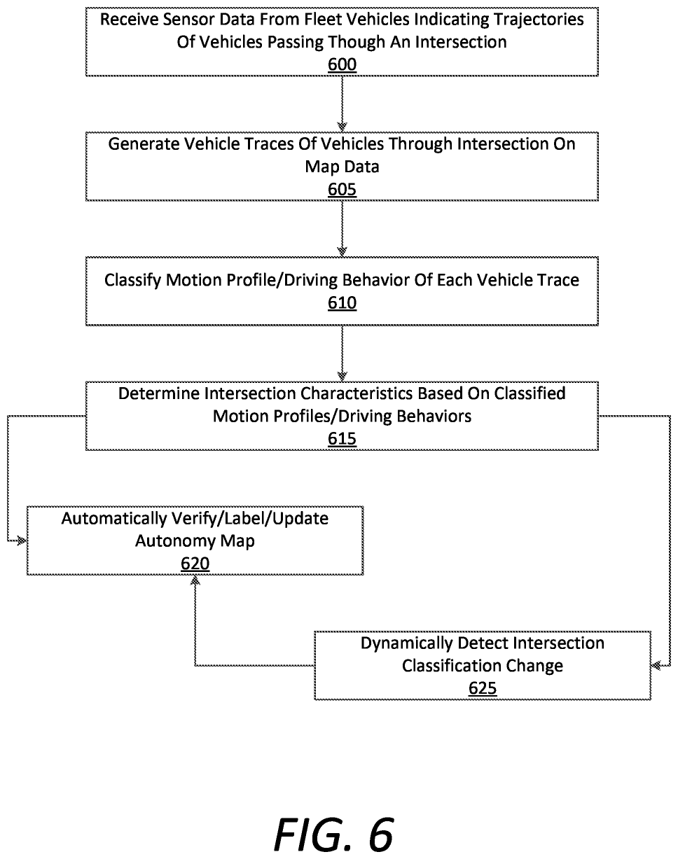

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with of FIGS. 5 and 6.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. In various examples, the computing system 100 can communicate, over the one or more networks, with fleet vehicles using the communication interface 140 to receive sensor data and implement the intersection classification methods described throughout the present disclosure. In certain embodiments, the communication interface 140 may be used to communicate with one or more other systems. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can receive sensor data from fleet vehicles over the one or more networks 150 using the communication interface 140. The control circuit 110 can process the sensor data through execution of instructions accessed from the non-transitory computer readable medium 120 to generate vehicle traces of the fleet vehicles through a particular intersection on map data. As described herein, the vehicle traces can indicate the respective trajectories of the vehicles through the intersection, as well as the behavior of the vehicles through the intersection. For example, the vehicle traces can indicate whether the vehicle stopped at the intersection, passed through the intersection without stopping, how long vehicles stopped at the intersection, yielding behavior (e.g., for right turns or pass-through vehicles), and the like. Accordingly, the vehicle traces can indicate acceleration, deceleration, coasting, standing, braking, and/or turning behavior of the fleet vehicles through the intersection.

The control circuit 110 may then classify the driving behaviors of the fleet vehicles through the intersection by determining any particular patterns over time that occur in the vehicle traces. The patterns can be indicative of traffic signals and signal states, traffic signal intervals (e.g., the amount of time elapsed for green lights and red lights respectively), specific signage for the intersection (e.g., stop signs, yield signs, etc.), speed limits, the locations of crosswalks, and the like. Thus, based on the classified driving behaviors and derived behavior patterns, the control circuit 110 can classify the intersection. As described in detail below, the classification of the intersection can be lane specific and can correspond to a set of pass-through characteristics or rules for the intersection. Such information can then be utilized by the control circuit 110 to, for example, label an autonomy map to include the pass-through information (e.g., right-of-way rules, signal controlled, sign controlled, etc.) for the intersection.

### System Description

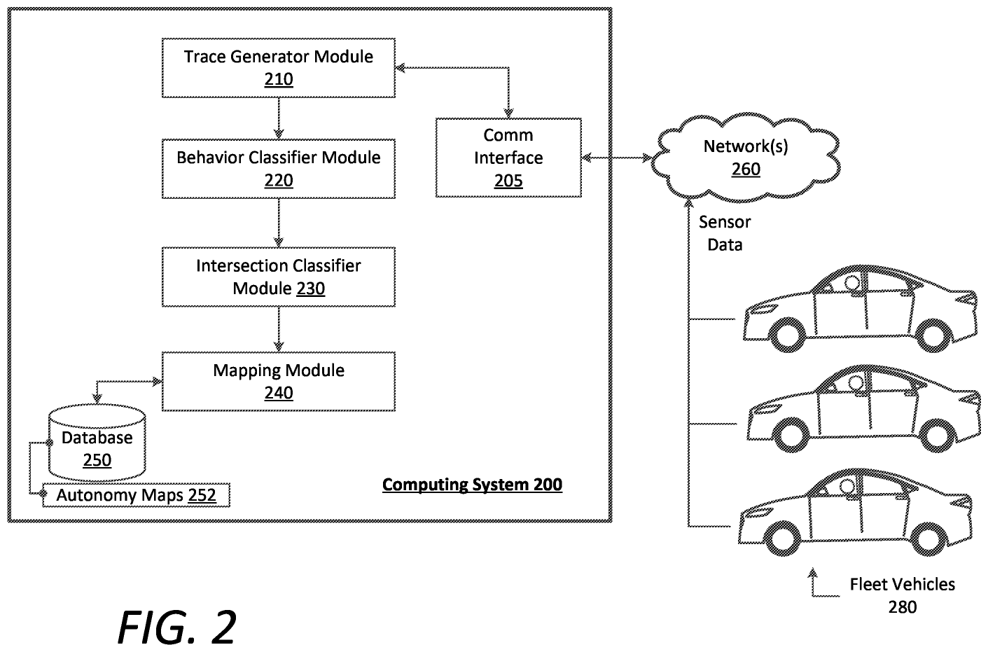

FIG. 2 is a block diagram illustrating an example computing system including specialized modules for implementing intersection classification based on sensor data from fleet vehicles, according to examples described herein. As provided herein, the computing system 200 can include a communication interface 205 to communicate, over one or more networks 260, with human-driven fleet vehicles 280 to receive sensor data that indicates each vehicle's motion and/or control inputs through a particular road segment or intersection. As further provided herein, the sensor data can be received from a set of sensors housed on each vehicle, such as a positioning system (e.g., a GPS device or other GNSS device) and/or one or more odometry sensors (e.g., wheel spin sensors, brake input sensors, steering input sensors, acceleration sensors). As such, the sensor data can comprise real-time position data and/or odometry information (e.g., speed, acceleration, yaw rate) of the fleet vehicles 280 as they traverse through the road segment or intersection.

In various implementations, the computing system 200 can include a trace generator module 210, a behavior classifier module 220, an intersection classifier module 230, and a mapping module 240. In further examples, the computing system 200 can include a database 250 storing a set of autonomy maps 252 utilized by autonomous and/or semi-autonomous vehicles for operating throughout a region. Specifically, the autonomy maps 252 can be created based on mapping vehicles that generate map data using a sensor suite (e.g., including LIDAR sensors, image sensors, etc.) as the mapping vehicles travel through a road network on which autonomous vehicles operate. The map data may be appended with one or more layers of labeled data that indicate the specified traffic rules (e.g., speed limits, signage, yield zones, crosswalk information, traffic signals, etc.) for any given road segment and/or intersection. The autonomous vehicles can continuously compare real-time sensor data generated by an on-board sensor suite with the relevant autonomy maps to perform localization, pose, and object classification processes that assist the autonomous vehicles in operating safely through the road network.

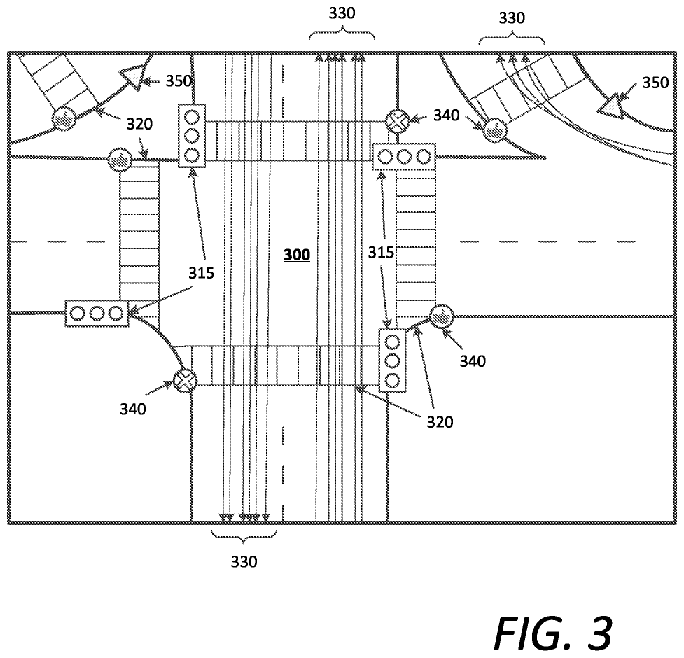

In certain examples, the trace generator module 210 can receive the sensor data from a subset of the fleet vehicles 280 that operate through a particular intersection. The trace generator module 210 can generate vehicle traces of the subset of fleet vehicles 280 through the particular intersection. As described below, in connection with FIG. 3, the vehicle traces can indicate each vehicle's path through the intersection. In further examples, the vehicle traces can be superimposed on map data to indicate the temporal sequence of motion of each vehicle through the intersection, such as traces of acceleration, coasting, deceleration, standing, and turning as the vehicle traverses the intersection.

In various implementations, the behavior classifier module 220 can process the vehicle traces and trajectories through the intersection to determine the overall driving patterns of the fleet vehicles 280 through the intersection. In certain examples, the behavior classifier module 220 can determine the road geometry of the intersection (e.g., based on satellite data of the intersection, road maps, ground truth maps, autonomy maps 252, etc.) to identify the individual pathways and lanes through the intersection (e.g., pass-through lanes, turning lanes, crosswalks, etc.). The behavior classifier module 220 can analyze each of the vehicle traces to assign particular lanes of the intersection to each of the vehicle traces. It is contemplated that by assigning the vehicle traces to particular lanes, the behavior classifier module 220 can identify specific locations or areas in each lane where a certain behavioral pattern occurs (e.g., accelerating, braking, standing, etc.).

Based on the behavioral patterns of the fleet vehicles 280 in each lane, the behavior classifier module 220 can perform a motion profile classification for each lane of the intersection. For example, when a grouping of vehicle traces for a particular direction through the intersection indicates a pattern of pass-through behavior and standing behavior, the behavior classifier module 220 can determine that the particular lane(s) that operate in the analyzed direction are controlled by a traffic signal. As another example, when the vehicle traces for a particular direction through the intersection indicate consistent stopping and accelerating behavior, the behavior classifier module 220 can determine that the particular lane(s) that operate in the analyzed direction are controlled by a stop sign.

As described herein, the behavior classifier module 220 can execute an artificial neural network (e.g., a recurrent neural network, convolutional neural network, etc.) or one or more machine-learning models to process the vehicle traces for each lane and perform the motion profile classification for each lane. In doing so, the behavior classifier module 220 can perform a temporal and statistical aggregation of the driving behaviors for each lane segment of the intersection to determine the driving patterns for the particular lane segment over time, and classify the driving behavior for the lane segment.

In various examples, the intersection classifier module 230 can compile the classified driving behaviors for each lane segment of the intersection to classify the intersection as, for example, a traffic signal-controlled intersection, a sign-controlled intersection, and any sub-class of the foregoing. In one example, the intersection classifier module 230 classifies the intersection heuristically. For example, the intersection classifier module 230 can determine, based on the classified driving behaviors for the lane segments through the intersection, a bi-modal distribution for each of the lane segments with a first cluster showing “drive-through” behavior and a second cluster showing a “stop-stand-proceed” behavior. Based on these clusters, the intersection classifier module 230 can determine that the intersection is controlled by a set of traffic lights.

As another example, the intersection classifier module 230 can identify a unimodal accumulation of driving behavior for the lane segments of an intersection as consistent “stop-and-proceed” behavior. In such an example, the intersection classifier module 230 can classify the intersection as a four-way stop intersection controlled by stop signs. Various other types and combinations of signal and sign-controlled intersections may be classified from the driving behaviors and motion profiles as determined from the vehicle traces. For example, the intersection classifier module 230 can classify intersections as two-way stop, pedestrian inclusive intersection (e.g., the presence of crosswalks), railway crossing, overpass or underpass (e.g., indicating traffic light-controlled turn lanes only), roundabout, T-intersections, Y-intersections, midblock pedestrian crossing, more than four leg intersection, etc.

It is contemplated that each intersection type may be derived by the intersection classifier module 230 based on the patterned driving behaviors determined over time by the behavior classifier module 220. It is further contemplated that the computing system 200 can performed such derivations solely on the basis of the vehicle traces as generated from the sensor data from the fleet vehicles 280 and the known road geometries of the intersections. Accordingly, the computing system 200 can perform the intersection classifications without the explicit identification of traffic signs and/or traffic signals at the intersections.

In various examples, the mapping module 240 can utilize the classified intersection information from the intersection classifier module 230 to generally train a ground truth map or existing autonomy map to include a set of rules for autonomous vehicles to pass through the intersection. In certain implementations, the mapping module 240 can verify labels on an existing autonomy map, modify an existing autonomy map to include, for example, pass-through rules for the intersection, or generate a new autonomy map for the intersection to include information corresponding to the classification of the intersection. In one example, the mapping module 240 can comprise an autonomy map verifier that determines whether right-of-way and pass-through rules labeled on existing autonomy maps 252 are accurate. For example, an autonomy map 252 stored in the database 250 or accessed remotely can include the intersection through which the fleet vehicles 280 traveled. Upon determining the classified intersection type, the mapping module 240 can perform a lookup of the relevant autonomy map that includes the intersection, and compare the labeled information for the intersection (e.g., as labeled by a human) with the pass-through information for the classified intersection type. In further examples, if the pass-through information does not match, the mapping module 240 can automatically flag the discrepancy for further processing and labeling, or automatically relabel the autonomy map with the pass-through information for the classified intersection.

As provided herein, the pass-through information can comprise the identification of traffic signals and/or traffic signs for a given intersection. In one example, a human-labeled autonomy map may include an intersection with mislabeled or hidden traffic signs and/or traffic signals. The mapping module 240 can utilize the classified intersection information from the intersection classifier module 230 to identify mislabeled traffic signals or signs, or missing labels for traffic signals or signs. In further examples, the mapping module 240 can automatically correct mislabeled traffic signals and signs, or can automatically include labels for traffic signals and signs for the intersection.

Additionally or alternatively, the mapping module 240 can automatically label existing autonomy maps recorded by mapping vehicles with a set of pass-through rules for the classified intersection. For example, the mapping module 240 can replace certain human labelling functions in creating autonomy maps 252 for autonomous and/or semi-autonomous vehicles. In such an example, mapping vehicles may still be utilized to record ground truth maps of a given road network, and the ground truth maps may be automatically imparted with intersection information (e.g., pass-through rules or signal and signage labels) for each intersection of the road network. In still further examples, the mapping module 240 can utilize the intersection classifications from the intersection classifier module 230 to generate autonomy maps with labels for each of the intersections.

In further examples, the classification of intersections can be used for route planning for autonomous vehicles. For example, the mapping module 240 can generate autonomy maps in which specific routes through a road network are enabled for autonomous driving based on the classified intersections. Such enabled routes can be prioritized based on traffic signal control due to increased safety and more robust capability of autonomous vehicles in handling traffic signal-controlled intersections. As such, when devising an autonomy grid comprise routes in which autonomous vehicle operation is permitted, the routes that prioritize traffic signal control may be utilized by the mapping module 240 as an additional optimization for routing (e.g., as opposed to solely distance and estimated time).

In further examples, the computing system 200 can further receive the sensor data dynamically and perform the intersection classification operations described herein in real-time. Accordingly, when the pass-through characteristics of an intersection change (e.g., a traffic sign-controlled intersection changes to a traffic signal-controlled intersection), the computing system 200 can detect the change based on the changed behavior of the vehicle traces through the intersection. Based on this change detection, the mapping module 240 can update the corresponding labels on the relevant autonomy map 252, and distribute the updated autonomy map 252 to any autonomous vehicles operating in the region including the intersection.

### Vehicle Traces

FIG. 3 depicts a mapped intersection 300 in which vehicle traces 330 are superimposed on map data over a time period based on sensor data from fleet vehicles, according to examples described herein. In the example shown in FIG. 3, an intersection 300 of a particular road network includes a set of vehicle traces 330 that are superimposed on the map data of the intersection 300. As described herein, the vehicle traces 330 can be superimposed based on sensor data received from human-driven fleet vehicles operating throughout a road network. While limited vehicle traces 330 are shown in FIG. 3 for illustrative purposes, in implementation, any number of vehicle traces (e.g., many hundreds or thousands) can be included.

As described throughout the present disclosure, various information for the intersection 300 may be derived from information included in the vehicle traces 330 (e.g., braking, accelerating, standing, coasting, turning, etc.). For example, the computing system 200 can process the vehicle traces to infer that the intersection 300 includes a set of traffic signals 315 (e.g., based on a bi-modal distribution of pass-through behavior of vehicles passing through the intersection 300. The computing system 200 can further infer that the intersection 300 includes a set of crosswalks 320 controlled by pedestrian signals 340 (e.g., based on deviations in wait times for vehicles stopped at the intersection 300). The computing system 200 can further determine the characteristics and lane makeup of the intersection 300 based on the vehicle traces 330. For example, in addition to identifying that the intersection 300 is traffic signal-controlled, the computing system 200 can further identify specific turning lanes that include yield signage 350 for crosswalks 320 based on the vehicle traces 330.

Upon classifying the intersection 300 and determining the various characteristics of the intersection 300, the mapping module 240 can perform the automatic verification and labeling techniques described herein. In one example, the mapping module 240 can include, on a relevant autonomy map, labels for the inferred traffic signals 315, crosswalks 320, pedestrian signals 340, and yield signage 350. In further examples, the mapping module 240 can label the intersection 300 with lane-specific pass-through information in accordance with the inferred traffic control elements.

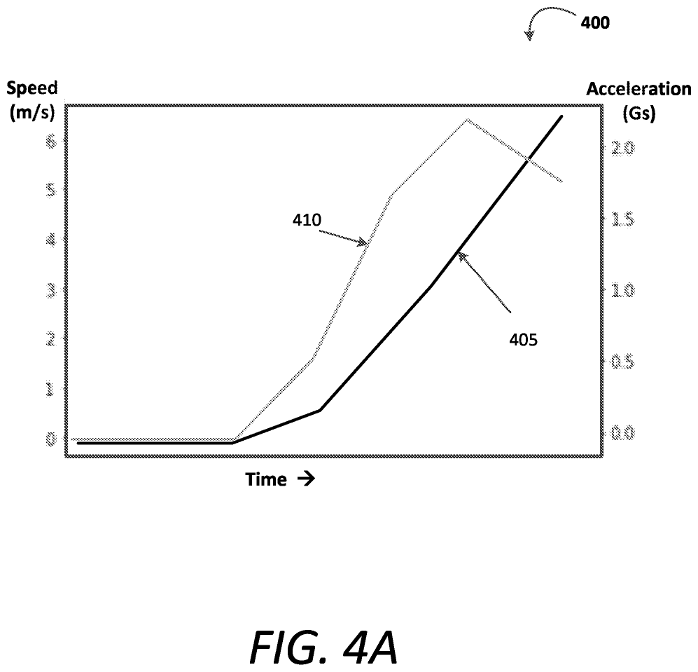

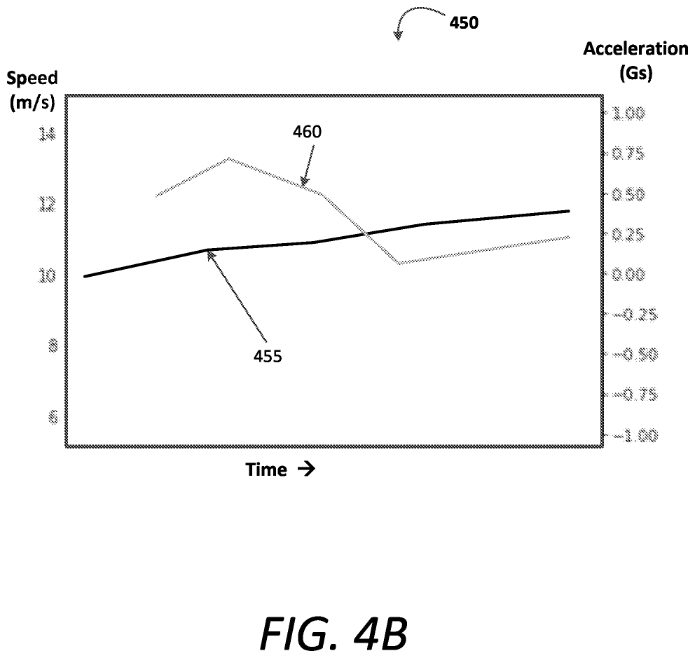

FIGS. 4A and 4B depict acceleration and speed information of the respective vehicle traces through an intersection, according to examples described herein. Referring to FIG. 4A, a graph 400 depicts speed 410 and acceleration 405 lines that can correspond to a particular vehicle trace 330 of FIG. 3. As shown in FIG. 4A, the information encoded in the vehicle trace 330 can include temporal values of the vehicle's speed 410 through the intersection 300, as well as temporal values of the vehicle's acceleration 405. In the example shown in FIG. 4A, the fleet vehicle stands at the intersection for a period of time and then proceeds to accelerate (e.g., implying a traffic signal turning green). As provided herein, the computing system 200 can process this vehicle trace information from multiple fleet vehicles traveling through the same intersection to determine that the intersection is traffic signal-controlled.

Referring to FIG. 4B, a graph 450 depicts speed 460 and acceleration 455 lines that can correspond to a particular vehicle trace 330 of FIG. 3. As shown in FIG. 4B, the information encoded in the vehicle trace 330 can include temporal values of the vehicle's speed 460 through the intersection 300, as well as temporal values of the vehicle's acceleration 455. In the example shown in FIG. 4B, the fleet vehicle accelerates slightly through the intersection 300 indicating either right-of-way over crossing lanes controlled by traffic signage, or a green light for a traffic signal-controlled intersection. As provided herein, the computing system 200 can process vehicle trace information from multiple fleet vehicles traveling through the same intersection to classify the intersection.

### Methodology

FIGS. 5 and 6 are flow charts describing methods of intersection classification based on sensor data from fleet vehicles, according to examples described herein. In the below discussion of the methods of FIGS. 5 and 6, reference may be made to reference characters representing certain features described with respect to the systems diagrams of FIGS. 1 and 2. Furthermore, the steps described with respect to the flow charts of FIGS. 5 and 6 may be performed by the computing systems 100, 200 as shown and described with respect to FIGS. 1 and 2. Further still, certain steps described with respect to the flow charts of FIGS. 5 and 6 may be performed prior to, in conjunction with, or subsequent to any other step, and need not be performed in the respective sequences shown.

Referring to FIG. 5, at block 500, the computing system 200 can receive sensor data from human-driven fleet vehicles 280 operating through an intersection. As described herein, the sensor data can include position data indicating the temporal positions of each fleet vehicle 280 as the fleet vehicle 280 traverses through the intersection. In further examples, the sensor data can include wheel spin information, speed and/or acceleration information, braking input data, yaw rate information, and the like. As further described herein, the sensor data can indicate the respective trajectories of the vehicles through the intersection.

At block 505, the computing system 200 can process the sensor data to classify driving behavior for each lane segment through the intersection. For example, the computing system 200 can generate vehicle traces for each vehicle through the intersection, where the vehicle traces can include information corresponding to braking, accelerating, standing, coasting, or turning behaviors as the vehicles proceed through the intersection. Based on the information included in the vehicle traces, the computing system 200 can identify behavioral driving patterns for each lane segment (e.g., passing-through, stopping and standing, stopping and proceeding, and the like).

At block 510, the computing system 200 can classify the intersection based on the classified driving behaviors to train a ground truth map to include rules for autonomous driving through the intersection. As described herein, the classified driving behaviors can be based on a bi-modal distribution of vehicles passing through the intersection (e.g., indicating a traffic signal-controlled intersection) or a unimodal accumulation of behavior (e.g., indicating a sign-controlled intersection). Thus, the computing system 200 generally infer, based on the sensor data, whether a particular intersection is traffic signal-controlled or traffic sign-controlled.

FIG. 6 is another flow chart describing a method of intersection classification based on sensor data from fleet vehicles, according to various examples. Referring to FIG. 6, at block 600, the computing system 200 can receive sensor data from fleet vehicles 280, wherein the sensor data indicates the trajectories of the vehicles as they pass through an intersection. At block 605, based on the sensor data, the computing system 200 can generate vehicle traces of the fleet vehicles through the intersection on map data. As described herein, the vehicle traces can comprise a temporal or chronological sequence of position information as the vehicles pass through the intersection, and can indicate braking, stopping, accelerating, standing, coasting, and turning behaviors of the vehicles.

At block 610, the computing system 200 can classify the motion profiles and/or driving behaviors of each vehicle trace. The computing system 200 can aggregate these classified motion profiles and/or driving behaviors to identify lane-specific patterns for the intersection (e.g., multiple behavioral clusters for a lane, a common behavioral accumulation for a lane, etc.). At block 615, based on the classified motion profiles and/or driving behaviors (e.g., indicating the lane-specific patterns), the computing system 200 can determine a set of characteristics for the intersection.

As provided herein, the set of characteristics for the intersection can include lane-specific traffic control information, such as whether a particular lane is controlled by a traffic signal, a yield sign, a stop sign, roundabout rules, and the like. The set of characteristics can further include whether and where pedestrian crosswalks exist in the intersection. In further examples, the computing system 200 can further infer lane-specific traffic signal intervals (e.g., how long red light and green light states last) for the intersection. The set of characteristics can further include the road geometry (e.g., respective numbers of directional lanes, lane width, intersection configuration, etc.) as well as any other specialized rules for the intersection. In still further examples, the set of characteristics can inherently include region specific regulations or norms for right-of-way (e.g., priority to right turning vehicles or priority to straight passing vehicles).

At block 620, the computing system 200 can automatically verify, label, and/or update a ground truth map or autonomy map to include pass-through information for the intersection. The pass-through information can comprise a set of rules (e.g., “follow traffic signal state,” “stop sign,” “yield to pedestrians,” etc.), and/or can comprise a set of labels indicating the traffic signals and/or signage that control the intersection. As discussed herein, the autonomy maps 252 can be utilized by semi-autonomous or fully autonomous vehicles for localization, pose, object classification, and other autonomous driving operations for safely navigating through a road network.

It is contemplated that the processes described herein may be implemented by the computing system 200 for “scene mining” purposes. For example, the computing system 200 can process the characteristics of each intersection of a road network to identify certain types of intersections (e.g., intersections that are conducive for autonomous driving). It is further contemplated that the intersection classification techniques described herein may be performed dynamically. Thus, at block 625, the computing system 200 may dynamically detect changes in the classification of a particular intersection based on the generated vehicle traces and classified driving behaviors. Such a change may result from permanent road construction, temporary power outages (e.g., changing a traffic signal-controlled intersection into an effective sign-controlled intersection), etc. Upon detecting a change in intersection classification, the computing system 200 can update the relevant autonomy map to indicate the change, at block 620.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

As provided herein, embodiments and features described can be combined with other embodiments and/or features described throughout the present disclosure. For example, the classification of driving behaviors and can be performed through any combination of heuristics and/or one or more machine learning techniques (e.g., through use of a recurrent neural network). As another example, the classification of intersections can also be performed through any combination of heuristics and/or one or more machine learning techniques. As stated herein, the absence of describing combinations should not preclude claiming rights to such combinations.

What is claimed is:

1. A computing system comprising:
a communication interface to communicate, over one or more networks, with human-driven vehicles operating throughout a region;
one or more processors;
a memory storing instructions that, when executed by the one or more processors, cause the computing system to:
receive, over the one or more networks, sensor data from a subset of the human-driven vehicles that have moved through an intersection in the region, the sensor data indicating a respective set of trajectories of respective human-driven vehicles through the intersection;
process the sensor data to classify driving behavior of each human-driven vehicle of the subset of human-driven vehicles through the intersection; and
classify the intersection to label an autonomy map to include pass-through information for at least one of autonomous vehicles or semi-autonomous vehicles driving through the intersection.

2. The computing system of claim 1, wherein the executed instructions further cause the computing system to:
superimpose each of the respective set of trajectories to a lane which is represented by map data of the intersection;
wherein the computing system classifies the driving behavior of each human-driven vehicle of the subset through the intersection based on superimposing each of the respective set of trajectories on the map data.

3. The computing system of claim 2, wherein the computing system classifies the intersection using at least one of a heuristic approach or a learning-based approach based on a temporal and aggregated distribution of the respective set of trajectories represented by the map data.

4. The computing system of claim 1, wherein the computing system classifies the intersection by determining a crossing-type for each lane segment of the intersection based on the respective set of trajectories.

5. The computing system of claim 4, wherein the crossing-type for the lane segment corresponds to at least one of a sign-controlled crossing-type, a signal-controlled crossing type, an all-way stop crossing type, a priority road crossing type, or a no control crossing type.

6. The computing system of claim 1, wherein each of the respective set of trajectories describes a chronological sequence of vehicle motion of a corresponding human-driven vehicle through the intersection.

7. The computing system of claim 1, wherein the computing system executes a learning-based approach to process the respective set trajectories and classify the driving behavior of each human-driven vehicle through the intersection.

8. The computing system of claim 1, wherein the pass-through information comprises at least one of (i) a set of pass-through rules for each lane of the intersection, or (ii) a set of labels indicating traffic signals and/or signage that control the intersection.

9. A non-transitory computer readable medium storing instructions that, when executed by one or more processors of a computing system, cause the computing system to:
receive, over one or more networks, sensor data from a subset of human-driven vehicles that have moved through an intersection in a region, the sensor data indicating a respective set of trajectories of respective human-driven vehicles through the intersection;
process the sensor data to classify driving behavior of each human-driven vehicle of the subset of human-driven vehicles through the intersection; and
classify the intersection to label an autonomy map to include pass-through information for at least one of autonomous vehicles or semi-autonomous vehicles driving through the intersection.

10. The non-transitory computer readable medium of claim 9, wherein the executed instructions further cause the computing system to:
superimpose each of the respective set of trajectories to a lane which is represented by map data of the intersection;
wherein the executed instructions cause the computing system to classify the driving behavior of each human-driven vehicle of the subset through the intersection based on superimposing each of the respective set of trajectories on the map data.

11. The non-transitory computer readable medium of claim 10, wherein the computing system classifies the intersection using at least one of a heuristic approach or a learning-based approach based on a temporal and aggregated distribution of the respective set of trajectories represented by the map data.

12. The non-transitory computer readable medium of claim 9, wherein the computing system classifies the intersection by determining a crossing-type for each lane segment of the intersection based on the respective set of trajectories.

13. The non-transitory computer readable medium of claim 12, wherein the crossing-type for the lane segment corresponds to at least one of a sign-controlled crossing type, a signal-controlled crossing type, an all-way stop crossing type, a priority road crossing type, or no control crossing type.

14. The non-transitory computer readable medium of claim 9, wherein each of the respective set of trajectories describes a chronological sequence of vehicle motion of a corresponding human-driven vehicle through the intersection.

15. The non-transitory computer readable medium of claim 9, wherein the computing system executes a learning-based approach to process the respective set trajectories and classify the driving behavior of each human-driven vehicle through the intersection.

16. The non-transitory computer readable medium of claim 9, wherein the pass-through information comprises at least one of (i) a set of pass-through rules for each lane of the intersection, or (ii) a set of labels indicating traffic signals and/or signage that control the intersection.

17. A computer-implemented method, the method being performed by one or more processors and comprising:
receiving, over one or more networks, sensor data from a subset of human-driven vehicles that have moved through an intersection in a region, the sensor data indicating a respective set of trajectories of respective human-driven vehicles through the intersection;
processing the sensor data to classify driving behavior of each human-driven vehicle of the subset of human-driven vehicles through the intersection; and
classifying the intersection to label an autonomy map to include pass-through information for at least one of autonomous vehicles or semi-autonomous vehicles driving through the intersection.

18. The computer-implemented method of claim 17, further comprising:
superimposing each of the respective set of trajectories to a lane which is represented by map data of the intersection;
wherein the one or more processors classify the driving behavior of each human-driven vehicle of the subset through the intersection based on superimposing each of the respective set of trajectories on the map data.

19. The computer-implemented method of claim 18, wherein the one or more processors classify the intersection using at least one of a heuristic approach or a learning-based approach based on a temporal and aggregated distribution of the respective set of trajectories represented by the map data.

20. The computer-implemented method of claim 17, wherein the one or more processors classify the intersection by determining a crossing-type for each lane segment of the intersection based on the respective set of trajectories.
